(19) United States
(12) Patent Application Publication
(10) Pub. No.: US 2025/0178629 A1
(43) Pub. Date: Jun. 5, 2025

(54) CONTROL DEVICE, DRIVER ASSIST METHOD, AND NONTRANSITORY COMPUTER STORAGE MEDIUM

(71) Applicant: TOYOTA JIDOSHA KABUSHIKI KAISHA, Aichi-ken (JP)

(72) Inventors: Takaya YAMASHITA, Nagoya-shi (JP); Yuki HATSUDE, Toyota-shi (JP); Hiroki SHIMAZU, Nisshin-shi (JP)

(21) Appl. No.: 18/955,982

(22) Filed: Nov. 22, 2024

(30) Foreign Application Priority Data
Nov. 30, 2023 (JP) 2023-203016

(51) Int. Cl. B60W 50/14; B60W 40/08

(52) U.S. Cl. CPC B60W 50/14; B60W 40/08; B60W 2050/143; B60W 2050/146; B60W 2540/225; B60W 2554/4041; B60W 2554/802

(57) ABSTRACT

A control device configured to detect a moving body present in the surroundings of a vehicle entering an assist area set in the surroundings of the vehicle and to provide driver assist when the moving body enters the assist area from a front part of the assist area based on the positional relationship between the front end position of the moving body and the vehicle or based on the positional relationship between the moving body and an eyellipse reference line set for each vehicle.

### FIELD

The present disclosure relates to a control device, driver assist method, and non-transitory computer storage medium.

### BACKGROUND

Japanese Unexamined Patent Publication No. 2021-26241 discloses, as a conventional attention drawing device, a blind spot monitor for detecting another vehicle running in a warning area constituting a blind spot region of a driver and providing the driver with an alert notification.

### SUMMARY

However, in the above-mentioned conventional alert device, when the host vehicle passes another vehicle, the driver is alerted when the rear end part of the other vehicle enters the warning area. For this reason, for example, when passing a truck, bus, or other particularly long other vehicle, despite the driver being able to visually recognize the other vehicle, the driver was liable to be unnecessarily alerted when the rear end part of the other vehicle has entered the warning area.

The present disclosure was made focusing on such a problem and has as its object to keep a driver from ending up being provided with unnecessary driver assist.

To solve the above problem, the control device according to one aspect of the present disclosure is configured to detect a moving body present in the surroundings of a vehicle entering an assist area set in the surroundings of the vehicle and to perform driver assist when the moving body enters the assist area from a front part of the assist area based on the positional relationship between the front end position of the moving body and the vehicle or based on the positional relationship between the moving body and an eyellipse reference line set for each vehicle.

Further, a driver assist method by a control device for performing driver assist of a vehicle according to another aspect of the present disclosure detects a moving body present in the surroundings of a vehicle entering an assist area set in the surroundings of the vehicle and performs driver assist when the moving body enters the assist area from a front part of the assist area based on the positional relationship between the front end position of the moving body and the vehicle or based on the positional relationship between the moving body and an eyellipse reference line set for each vehicle.

Further, according to another aspect of the present disclosure, there is provided a non-transitory computer storage medium including a computer program. The computer program makes a computer run processing for detecting a moving body present in the surroundings of a vehicle entering an assist area set in the surroundings of the vehicle and performing driver assist when the moving body enters the assist area from a front part of the assist area based on the positional relationship between the front end position of the moving body and the vehicle or based on the positional relationship between the moving body and an eyellipse reference line set for each vehicle.

According to these aspects of the present disclosure, it is possible to perform driver assist after judging to what extent a moving body can be visually recognized from a host vehicle, so it is possible to keep a driver from ending up being provided with unnecessary driver assist.

### BRIEF DESCRIPTION OF DRAWINGS

FIG. 1 is a schematic view of the configuration of a driver assist apparatus according to a first embodiment of the present disclosure.

FIG. 2 is a view for explaining a distance measuring sensor.

FIG. 3 is a view showing one example of a driver assist area set in advance in the surroundings of a host vehicle.

FIG. 4 is a view showing one example of a scenario in which another vehicle enters the driver assist area from a rear part of the driver assist area.

FIG. 5 is a view showing one example of a scenario in which another vehicle enters the driver assist area from a front part of the driver assist area.

FIG. 6 is a view showing one example of a scenario in which another vehicle entering from a front part of the driver assist area has completely entered the driver assist area.

FIG. 7A is a flow chart for explaining details of driver assist control according to a first embodiment of the present disclosure for another vehicle which has entered the driver assist area from a rear of the host vehicle.

FIG. 7B is a flow chart for explaining details of driver assist control according to a first embodiment of the present disclosure for another vehicle which has entered the driver assist area from a front of the host vehicle.

FIG. 8 is a view for explaining an eyellipse reference line.

FIG. 9 is a flow chart for explaining details of driver assist control according to a second embodiment of the present disclosure for another vehicle which has entered the driver assist area from a front of the host vehicle.

### DESCRIPTION OF EMBODIMENTS

Below, referring to the drawings, embodiments of the present disclosure will be explained in detail. Note that, in the following explanation, similar components will be assigned the same reference notations.

### First Embodiment

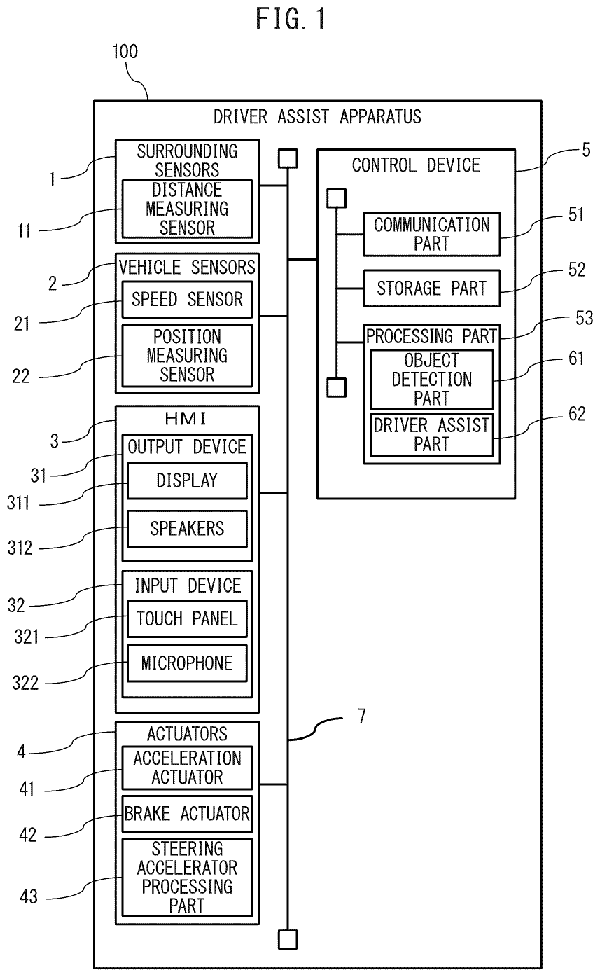

FIG. 1 is a schematic view of the configuration of a driver assist apparatus 100 according to a first embodiment of the present disclosure.

The driver assist apparatus 100 is provided with surrounding sensors 1, vehicle sensors 2, an HMI (human machine interface) 3, actuators 4, and a control device 5. The surrounding sensors 1, vehicle sensors 2, HMI 3, actuators 4, and control device 5 are connected to be able to communicate through an internal vehicle network 7 based on the standard of the Control Area Network.

The surrounding sensors 1 are sensors for generating surrounding data showing the situation in the surroundings of the vehicle at which the driver assist apparatus 100 performs driver assist (below, referred to as the “host vehicle”). In the present embodiment, as a surrounding sensor 1, a distance measuring sensor 11 for measuring the distances to vehicles, pedestrians, and other objects present in the surroundings of the host vehicle is provided.

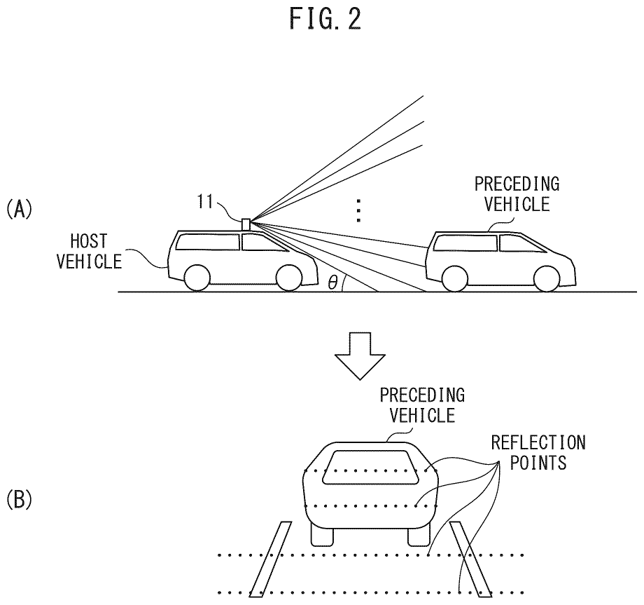

The distance measuring sensor 11 emits a plurality of laser beams, radio waves, ultrasonic waves, etc. different in emission angle Θ to the distance measurement region of the surroundings of the host vehicle (front, sides, and back) horizontal and in parallel as shown in (A) of FIG. 2 and receives the reflected beams of the emitted laser beams or the reflected waves of the emitted radio waves or ultrasonic waves. Note that, in FIG. 2, to prevent complexity of the drawings and facilitate understanding, the state is shown where the plurality of laser beams are emitted to a front of the host vehicle. Further, the distance measuring sensor 11 measures the distances to the road and obstacles (for example, buildings, preceding vehicles and following vehicles on the road, adjacent vehicles, oncoming vehicles, and other such running vehicles, stopped vehicles, curbs, fallen objects, pedestrians, etc.) present inside the distance measurement region based on the received reflected beams or reflected waves. The distances up to the road or obstacles, as shown in (B) of FIG. 2, are acquired for each reflection point (emission point). The distance measuring sensor 11 links the distances up to the reflection points and coordinate information of the reflection points, then sends them as surrounding data (distance measurement data) to the control device 5.

As a distance measuring sensor 11 for emitting laser beams, for example, a lidar (light detection and ranging device) may be mentioned. As a distance measuring sensor 11 for emitting radio waves, for example, a millimeter wave radar sensor may be mentioned. As a distance measuring sensor 11 for emitting ultrasonic waves, for example, a sonar device may be mentioned. FIG. 2 shows an example of attachment of a lidar device as the distance measuring sensor 11 to the roof of the host vehicle, but the location of attachment of the distance measuring sensor 11 is not limited to a roof. For example, it may be the front bumper, rear bumper, etc. of the host vehicle. Further, for example, a plurality of lidar devices, a plurality of millimeter wave radar sensors, etc. may also be provided as distance measuring sensors 11. Further, in addition to the distance measuring sensor 11, a camera capturing vehicles, pedestrians, and other objects present in the surroundings of the host vehicle may also be provided as the surrounding sensor 1.

The vehicle sensors 2 are sensors for generating vehicle data showing the situation of the host vehicle. In the present embodiment, as the vehicle sensors 2, for example, a speed sensor 21 for generating speed data showing a running speed of the host vehicle and, for example, a position measurement sensor 22 for generating current position data showing the current position of the host vehicle such as the longitude and latitude etc. are provided. However, the vehicle sensors 2 are not limited to these sensors. The vehicle sensors 2 send the acquired data (for example, the speed data and current position data) as vehicle data to the control device 5.

The HMI 3 is a user interface for transfer of information between the host vehicle and its occupants. The HMI 3 is provided with output devices 31 for providing notifications to the vehicle occupants through the physical senses of the vehicle occupants (for example, sight, hearing, touch, etc.) and input devices 32 for the vehicle occupants to perform input operations and response operations. In the present embodiment, as output devices 31, a display (for example, meter display, center display, heads-up display, etc.) 311 and speakers 312 are provided. As the input devices 32, a touch panel 321 and microphone 322 are provided.

The HMI 3 displays information corresponding to a display signal received from the control device 5 (for example, text information or graphic information) on the display 311 and outputs audio corresponding to an audio signal from the speakers 312. Further, the HMI 3 sends data input by the touch panel or input by voice by the vehicle occupant through the input devices 32 (below, referred to as the “passenger input data”) to the control device 5.

The HMI 3 may be mounted in the host vehicle in advance or may be a smartphone or other terminal held by a vehicle occupant. In the latter case, for example, information may be transferred by short distance wireless between the host vehicle and terminal of the vehicle occupant, the terminal of the vehicle occupant and an outside server (not shown) may communicate with each other, and information may be transferred indirectly through the server.

The actuators 4 are devices used for controlling operations of the host vehicle. In the present embodiment, as the actuators 4, acceleration actuators 41 for controlling acceleration of the host vehicle (for example, at least one of the engine and motor), brake actuators 42 for controlling braking of the host vehicle (for example, a hydraulic actuator), and steering actuators 43 for controlling steering of the host vehicle (for example, a steering motor) are provided.

The control device 5 is an ECU (electronic control unit) provided with a communication part 51, storage part 52, and processing part 53.

The communication part 51 has a communicate interface circuit for connecting the control device 5 to the internal vehicle network 7. The communication part 51 supplies the various data received from the sensors 1 and 2, the HMI 3, etc. to the processing part 53. Further, the communication part 51 outputs the various signals output from the processing part 53 to the HMI 3, actuators 4, etc.

The storage part 52 has an HDD (hard disk drive), SSD (solid state drive), semiconductor memory, or other storage medium and stores various computer programs and data etc. used for processing at the processing part 53.

The processing part 53 has one or more CPUs (central processing units) and their peripheral circuits and runs various computer programs stored in the storage part 52. The processing part 53 is for examples a processor. The processing part 53 may further have other processing circuits such as a logical operation unit, numerical operation unit, or graphic processing unit. The processing part 53 performs processing in accordance with a computer program so as to function as an object detection part 61 and driver assist part 62 and operate as a function part (module) realizing a predetermined function. In the following explanation, if explaining the processing using the function parts 61 and 62 as subjects, the processing part 53 runs programs for realizing the function parts 61 and 62.

Below, the content of the specific processing performed at the control device 5 will be explained. That is, the content of the function parts 61, 62 realized by the processing part 53 performing processing in accordance with the programs will be explained.

The object detection part 61 recognizes another vehicle present in the surroundings of the host vehicle based on the surrounding data. In the present embodiment, the object detection part 61 groups reflection points satisfying predetermined conditions among the plurality of reflection points detected by the distance measuring sensor 11 as reflection points of the laser beams etc. reflected from the same object to thereby recognize another vehicle present in the surroundings of the host vehicle. Further, the object detection part 61 tracks the recognized other vehicle along with time to calculate the position and speed of the object. Note that, the method of detection of an object is not limited to such a method. Various known techniques may be used for detection.

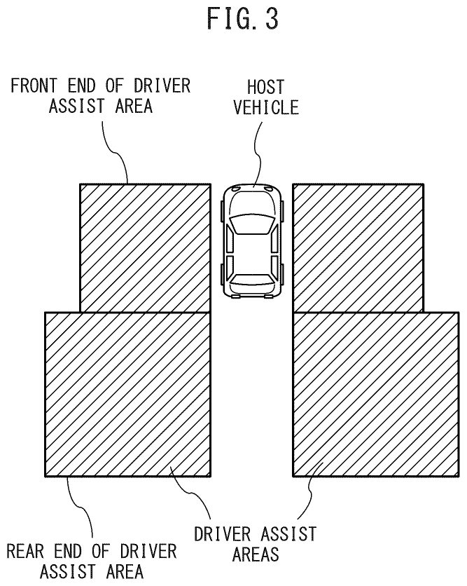

The driver assist part 62 performs driver assist to the driver if the other vehicle recognized by the object detection part 61 enters a driver assist area set in advance in the surroundings of the host vehicle (see FIG. 3). As driver assist to the driver, the driver assist part 62 can, for example, use the HMI 3 to perform various notifications of the presence of another vehicle in the driver assist area (for example, a notification by turning on or flashing an indicator, a notification by a message, a notification by voice, etc.) Further, as driver assist to the driver, the driver assist part 62 can, for example, in addition to notifications by the HMI 3, use actuators 4 to control running of the host vehicle (for example, acceleration, deceleration, avoidance, etc.) In the present embodiment, as driver assist to the driver, the driver assist part 62 flashes an indicator on the meter display to thereby provide an alert notification to the driver.

Below, referring to FIG. 3 to FIG. 7B, driver assist by the driver assist part 62 will be explained in further detail.

FIG. 3 is a view showing one example of a driver assist area set in advance in the surroundings of the host vehicle.

As shown in FIG. 3, the driver assist area is made the area to the sides and rear of the host vehicle which a driver has difficulty in direct viewing. In the present embodiment, the front end position of the driver assist area is set to the same position as the front end position of the host vehicle.

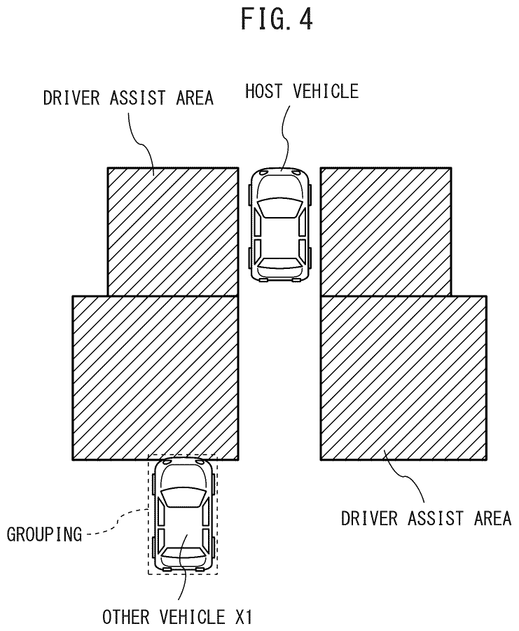

Here, if another vehicle has approached from the rear of the host vehicle (if the other vehicle enters the driver assist area from the rear part of the driver assist area), it is preferable to inform the driver of the presence of the other vehicle as early as possible. For this reason, as shown in FIG. 4, when the other vehicle X1 has entered the driver assist area from the rear part of the driver assist area, it is preferable to provide the driver with an alert notification at the point of time when the front end part of the other vehicle X1 enters the driver assist area.

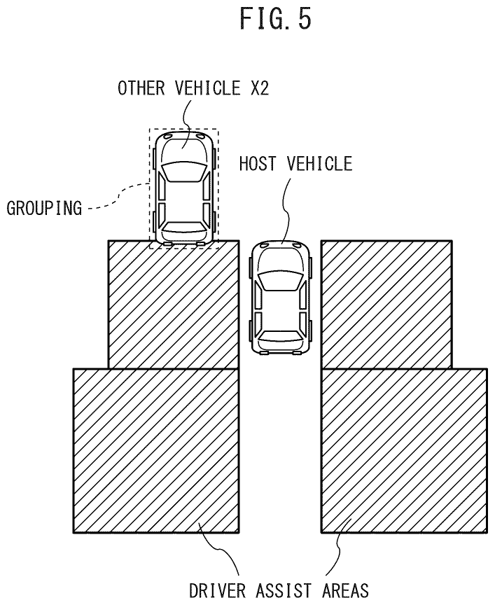

On the other hand, if the host vehicle finishes passing another vehicle in the front (if the other vehicle enters the driver assist area from a front part of the driver assist area), the driver recognizes the presence of the other vehicle. For this reason, as shown in FIG. 5, when the other vehicle X2 has entered the driver assist area from a front part of the driver assist area, if providing the driver with an alert notification at the point of time when the rear end part of the other vehicle X2 has entered the driver assist area, a alert notification is liable to be provided regardless of driver being able to recognize the other vehicle X2. Depending on the driver, such a notification is liable to be felt as bothersome.

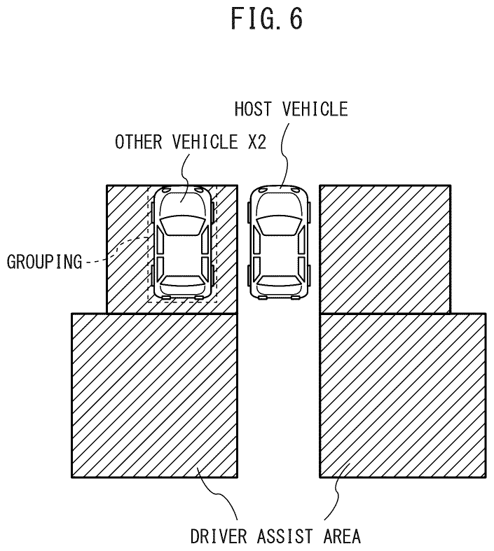

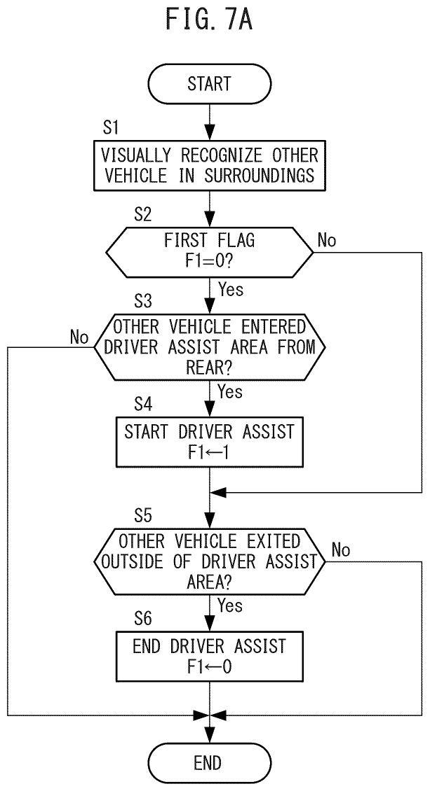

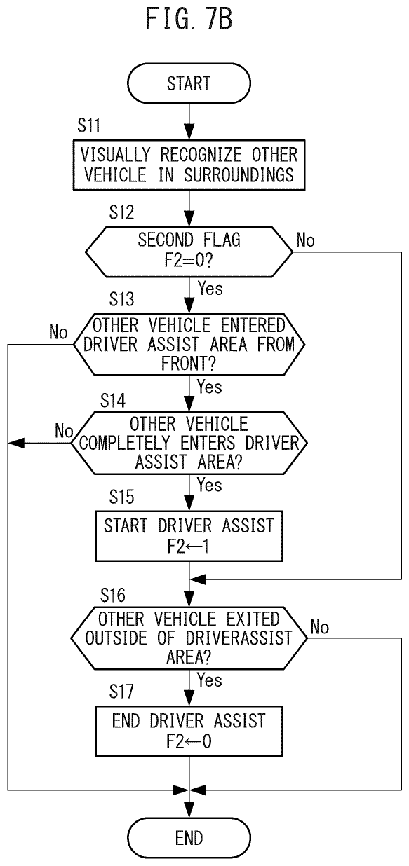

Therefore, in the present embodiment, the alert notification was made to be provided based on the positional relationship between the front end part of the other vehicle and the host vehicle when the other vehicle has entered the driver assist area from a front part of the driver assist area. Specifically, as shown in FIG. 6, the alert notification was made to be provided after the front end part of the other vehicle X2 entered the front end position of the driver assist area determined in accordance with the position of the host vehicle. In other words, the alert notification was limited until the front end part of the other vehicle X2 reached the front end position of the driver assist area. Below, referring to FIG. 7A and FIG. 7B, details of the driver assist control according to the present embodiment performed by the driver assist part 62 and in turn the control device 5 will be explained.

FIG. 7A is a flow chart for explaining details of driver assist control for another vehicle which has entered the driver assist area from the rear of the host vehicle. The control device 5 repeatedly performs the present routine at a predetermined processing cycle.

At step S1, the control device 5 recognizes another vehicle present in the surroundings of the host vehicle.

At step S2, the control device 5 judges whether a first flag F1 has been set to “0”. The first flag F1 is a flag which is set to “1” when performing driver assist with respect to another vehicle which has entered the driver assist area from the rear of the host vehicle. The initial value is set to “0”. The control device 5 proceeds to the processing of step S3 if the first flag F is set to “0”. On the other hand, the control device 5 proceeds to the processing of step S5 if the first flag F is “1”.

At step S3, the control device 5 judges whether the recognized other vehicle has entered the driver assist area from the rear of the host vehicle. For example, the control device 5, as shown in FIG. 4, can judge that the other vehicle X1 recognized by the grouping has entered the driver assist area from the rear of the host vehicle when the front end part of the other vehicle X1 at the rear has reached the rear end of the driver assist area. The control device 5 proceeds to the processing of step S4 if the recognized other vehicle has entered the driver assist area from the rear of the host vehicle. On the other hand, the control device 5 ends the current processing if the recognized other vehicle has not entered the driver assist area from the rear of the host vehicle.

At step S4, the control device 5 starts the driver assist to the driver and sets the first flag F1 to “1”. As explained above, in the present embodiment, as the driver assist to the driver, the control device 5 sends an alert notification to the driver through the HMI 3.

At step S5, the control device 5 judges if the other vehicle entering the driver assist area from the rear of the host vehicle has exited to the outside of the driver assist area. In the present embodiment, if the rear end of the other vehicle entering the driver assist area from the rear of the host vehicle is positioned at the front from the front end of the driver assist area or the front end of the other vehicle is positioned at the rear from the rear end of the driver assist area, the control device 5 judges that the other vehicle has exited to the outside of the driver assist area and proceeds to the processing of step S6 and if not, ends the current processing and continues the driver assist.

At step S6, the control device 5 ends the driver assist to the driver and returns the first flag F1 to “0”.

FIG. 7B is a flow chart for explaining details of driver assist control for another vehicle which has entered the driver assist area from the front of the host vehicle. The control device 5 repeatedly performs the present routine at a predetermined processing cycle.

At step S11, the control device 5 recognizes another vehicle present in the surroundings of the host vehicle.

At step S12, the control device 5 judges whether a second flag F2 has been set to “0”. The second flag F2 is a flag which is set to “1” when performing driver assist with respect to another vehicle which has entered the driver assist area from the front of the host vehicle. The initial value is set to “0”. The control device 5 proceeds to the processing of step S13 if the second flag F2 is set to “0”. On the other hand, the control device 5 proceeds to the processing of step S16 if the second flag F2 is “1”.

At step S13, the control device 5 judges whether the recognized other vehicle has entered the driver assist area from the front of the host vehicle. For example, the control device 5, as shown in FIG. 5, can judge that the other vehicle X2 at the front recognized by the grouping has entered the driver assist area from the front of the host vehicle when the rear end part of the other vehicle X2 has reached the front end of the driver assist area. The control device 5 proceeds to the processing of step S14 if the recognized other vehicle has entered the driver assist area from the front of the host vehicle. On the other hand, the control device 5 ends the current processing if the recognized other vehicle has not entered the driver assist area from the front of the host vehicle.

At step S14, the control device 5 judges if the other vehicle entering the driver assist area from the front of the host vehicle had completely entered the driver assist area. For example, the control device 5, as shown in FIG. 6, can judge that the other vehicle X2 at the front recognized by the grouping has completely entered the driver assist area when the front end part of the other vehicle X2 has reached the front end of the driver assist area. The control device 5 proceeds to the processing of step S15 if the other vehicle entering the driver assist area from the front of the host vehicle has completely entered the driver assist area. On the other hand, the control device 5 ends the current processing if the other vehicle entering the driver assist area from the front of the host vehicle has not completely entered the driver assist area. That is, it limits the alert notification.

Note that, whether the front end part of the other vehicle has reached the front end of the driver assist area can, for example, be judged by the following method. That is, it is possible to divide the total length [m] of the other vehicle X2 in the front recognized by the grouping by the relative speed [m/s] of the host vehicle and other vehicle X2 after the other vehicle X2 enters the driver assist area so as to calculate the estimated time period [s] from when the other vehicle X2 enters the driver assist area to when the front end part of that other vehicle X2 reaches the front end of the driver assist area. Therefore, it is possible to judge that the front end part of the other vehicle X2 has reached the front end of the driver assist area when the estimated time period has elapsed from the current time. Further, for example, it is possible to track the other vehicle X2 entering the driver assist area from the front of the host vehicle over time and judge that the front end part of the other vehicle X2 has reached the front end of the driver assist area after it is no longer possible to detect the other vehicle X at the front end part of the driver assist area after entering the driving area.

At step S15, the control device 5 starts driver assist to the driver and sets the second flag F2 to “1”. As explained above, in the present embodiment, as driver assist to the driver, the control device 5 provides the driver with alert notifications through the HMI 3.

At step S16, the control device 5 judges whether another vehicle entering the driver assist area from the front of the host vehicle has exited to the outside of the driver assist area. In the present embodiment, the control device 5 judged that the other vehicle has existed to the outside of the driver assist area and proceeds to the processing of step S17 if the front end of the other vehicle entering the driver assist area from the front of the host vehicle is positioned at the rear from the rear end of the driver assist area or if the rear end of the other vehicle is positioned at the front from the front end of the driver assist area (or if the front end of the other vehicle is positioned in front from the front end of the driver assist area). If not, it ends the current processing and continues the driver assist.

At step S17, the control device 5 ends the driver assist to the driver and returns the second flag F2 to “0”.

The control device 5 according to the present embodiment explained above is configured to detect another vehicle (moving body) present in the surroundings of the host vehicle entering a driver assist area (assist area) set in the surroundings of the host vehicle and to provide driver assist based on the positional relationship of the front end position of the other vehicle and the host vehicle when the other vehicle enters the driver assist area from a front part of the driver assist area.

Due to this, according to the present embodiment, it is possible to perform driver assist after judging to what extent another vehicle can be visually recognized from the host vehicle based on the front end position of the other vehicle, so it is possible to provide the driver of the host vehicle with suitable driver assist.

In particular, in the present embodiment, the front end position of the driver assist area is at the same position as the front end position of the host vehicle. The control device 5 is configured so as to perform driver assist when the other vehicle has completely entered the driver assist area, that is, when the front end position of the other vehicle and the front end position of the driver assist area become the same position, and is configured so as provide, as driver assist, alert notification to the driver through the HMI 3 (notification device) for providing notifications to the driver of the host vehicle.

For this reason, it is possible to keep the driver from ending up receiving alert notification when the driver of the host vehicle is able to sufficiently visually recognize another vehicle.

### Second Embodiment

Next, a second embodiment of the present disclosure will be explained. The present embodiment differs from the first embodiment on the point of starting driver assist to the driver (alert notification) based on an eyellipse reference line used as a reference for the field of vision of the driver when another vehicle enters the driver assist area from a front of the host vehicle. Below, this point of difference will be focused on in the explanation.

As explained earlier referring to FIG. 5, if the host vehicle finishes passing the other vehicle X2 in the front (if the other vehicle enters the driver assist area from a front part of the driver assist area), the driver recognizes the presence of the other vehicle X2, so if ending up providing alert notification regardless of the driver being able to visually recognize the other vehicle X2, depending on the driver, such a notification is liable to be felt as bothersome.

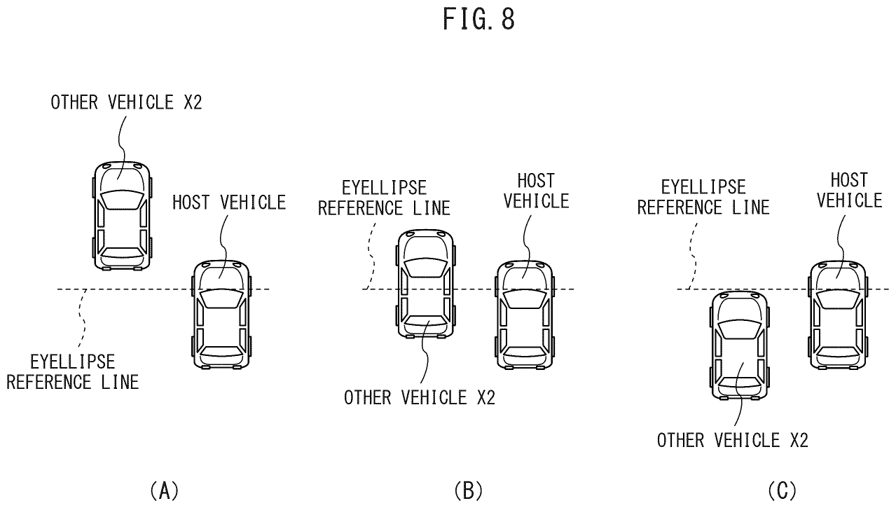

Therefore, in the present embodiment, as shown in FIG. 8, it was made to judge whether to start driver assist to the driver (alert notification) based on the eyellipse reference line used as reference of the field of vision of the driver.

Note that, “eyellipse”, defined by ISO4513, is the ellipse showing the eye range of the right eye and left eye of a driver (statistically showing the distribution of positions of the eyes of a driver) by a side view and a plan view. The eyellipse reference line in the present embodiment is the reference line in the vehicle width direction (left-right direction) shown on the eyellipse. The eyellipse reference line can be set for each model, for example, in accordance with the Japan Industrial Standard (JIS D 0021; Driver Eye Range of Automobile).

As shown in (A) of FIG. 8, if the host vehicle finishes passing another vehicle X2 in the front, when the other vehicle X2 is positioned in front of the eyellipse reference line, that is, when the rear end of the other vehicle X2 is positioned in front of the eyellipse reference line, the driver can visually recognize the other vehicle X2 as a whole. Therefore, when the rear end of the other vehicle X2 is positioned in front of the eyellipse reference line, alert notification becomes unnecessary.

On the other hand, as shown in (B) of FIG. 8, if the host vehicle finishes passing the other vehicle X2 in the front, when the other vehicle X2 is positioned on the eyellipse reference line, the driver cannot visually recognize the other vehicle X2 as a whole, but can visually recognize part of it. Therefore, when the other vehicle X2 is positioned on the eyellipse reference line, alert notification is not essential. Therefore, the state where the other vehicle X2 is positioned on the eyellipse reference line can be said to be a state where alert notification can be given in accordance with need at any timing with the aim of improving the balance of safety and the bother of the alert notification.

Further, as shown in (C) of FIG. 8, if the host vehicle finishes passing the other vehicle X2 in the front, when the other vehicle X2 is positioned at the rear of the eyellipse reference line, that is, when the front end of the other vehicle X2 is positioned at the rear of the eyellipse reference line, the driver will soon become unable to visually recognize the other vehicle X2. Therefore, when the front end of the other vehicle X2 is positioned at the rear of the eyellipse reference line, alert notification becomes essential.

Therefore, in the present embodiment, if the other vehicle has entered the driver assist area from a front part of the driver assist area, the alert notification was made to be given when the front end of the other vehicle X2 reached the eyellipse reference line. In other words, if another vehicle has entered the driver assist area from a front part of the driver assist area, the alert notification was made to be limited until the front end of the other vehicle X2 reached the eyellipse reference line.

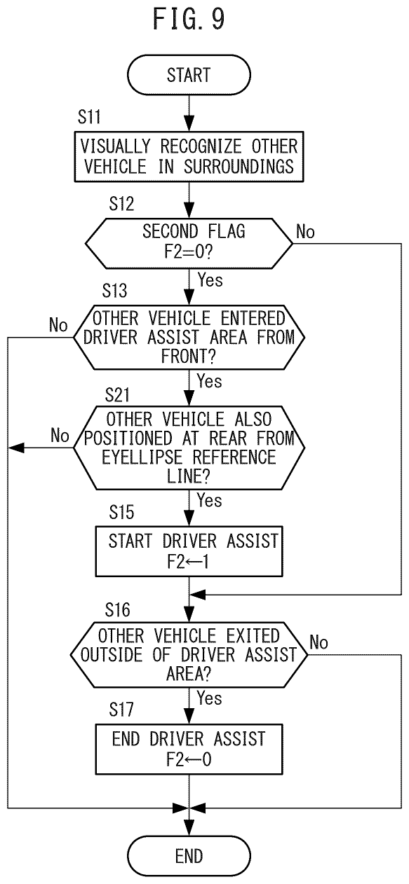

FIG. 9 is a flow chart for explaining details of driver assist control for another vehicle which has entered the driver assist area from a front of the host vehicle. The control device 5 repeatedly performs the present routine at a predetermined processing cycle. Note that, in FIG. 9, the contents of the processing at steps S11 to S13 and S15 to S17 are similar to the first embodiment, so here the explanations will be omitted.

At step S21, the control device 5 judges whether the other vehicle entering the driver assist area from the front of the host vehicle is positioned at the rear from the eyellipse reference line, that is, if the front end of that other vehicle has reached the eyellipse reference line. If the front end of the other vehicle entering the driver assist area from the front of the host vehicle reaches the eyellipse reference line, the control device 5 proceeds to the processing of step S15. On the other hand, if the front end of the other vehicle entering the driver assist area from the front of the host vehicle does not reach the eyellipse reference line, the control device 5 ends the current processing. That is, the notification for drawing attention is limited.

The control device 5 according to the present embodiment explained above is configured to detect another vehicle (moving body) present in the surroundings of the host vehicle entering the driver assist area set in the surroundings of the host vehicle and to perform driver assist based on the positional relationship of the other vehicle and the eyellipse reference line set in accordance with the type (model) of the host vehicle when the other vehicle enters the driver assist area from a front part of the driver assist area.

In this way, according to the present embodiment, it is possible to perform driver assist after judging to what extent the other vehicle can be seen from the host vehicle based on the positional relationship of the other vehicle and the eyellipse reference line of the host vehicle, so it is possible to provide the driver of the host vehicle with suitable driver assist.

In particular, the control device 5 according to the present embodiment is configured to perform driver assist when judging that the other vehicle is positioned in back of the eyellipse reference line, that is, when the front end position of the other vehicle and the eyellipse reference line of the host vehicle have become the same position, and is configured to provided the driver with an alert notification through the HMI 3 (notification device) for notifying the driver of the host vehicle as driver assist.

For this reason, when the driver of the host vehicle sees the other vehicle, it is possible to keep the driver from being sent an alert notification.

Above, embodiments of the present disclosure were explained, but the embodiments only show some of the applications of the present disclosure and are not meant to limit the technical scope of the present disclosure to the specific configurations of the embodiments.

For example, in the above first embodiment, the control device 5 was configured so as to perform driver assist if the other vehicle entered the driver assist area from a front of the host vehicle when the front end position of the other vehicle and the front end position of the driver assist area have become the same position. However, the control device 5 may also be configured so as to perform driver assist when the distance in the vehicle front-back direction between the front end position of the other vehicle and the front end position of the driver assist area has become less than or equal to a predetermined distance. That is, considering the case of driver missing seeing the other vehicle or other risk, the alert notification may be given somewhat earlier compared with the first embodiment. Due to this, it is possible to improve the balance between safety and the bother of alert notification while sending the driver an alert notification.

Further, for example, in the above first embodiment, the front end position of the driver assist area was set to the same position as the front end position of the host vehicle. However, the front end position of the driver assist area may be set to any position from the front end position of the host vehicle to the eyellipse reference line.

Further, for example, in the above second embodiment, driver assist was performed if the other vehicle entered the driver assist area from a front of the host vehicle when the front end of the other vehicle reached the eyellipse reference line. However, considering the case of the driver missing seeing the other vehicle or other risk, it is also possible to perform driver assist at any timing where the other vehicle is positioned on the eyellipse reference line. Due to this, it is possible to improve the balance between safety and the bother of alert notification while sending the driver an alert notification.

Further, in the above embodiments, the computer programs run at the control device 5 (for example, driver assist control) may be provided in a form recorded at a computer readable portable recording medium such as a semiconductor memory, magnetic recording medium, or optical recording medium.

Further, the above embodiments may be suitably combined.

1. A control device configured:
to detect a moving body present in the surroundings of a vehicle entering an assist area set in the surroundings of the vehicle; and
to provide driver assist when the moving body enters the assist area from a front part of the assist area based on the positional relationship between the front end position of the moving body and the vehicle or based on the positional relationship between the moving body and an eyellipse reference line set for each vehicle.

2. The control device according to claim 1, configured to provide driver assist when the front end position of the moving body and the front end position of the assist area become the same position.

3. The control device according to claim 1, configured to provide driver assist when the moving body has completely entered the assist area.

4. The control device according to claim 3, configured to judge that the moving body has completely entered the assist area when the front end position of the moving body and the front end position of the assist area become the same position.

5. The control device according to claim 1, configured to provide driver assist when a distance in the vehicle front-back direction between the front end position of the moving body and the front end position of the assist area becomes less than or equal to a predetermined distance.

6. The control device according to claim 1, wherein
the front end position of the assist area is the same position as the front end position of the vehicle.

7. The control device according to claim 1, wherein
the front end position of the assist area is positioned in a span from the front end position of the vehicle to the eyellipse reference line set for each vehicle.

8. The control device according to claim 1, configured to provide driver assist when the moving body is positioned on the eyellipse reference line.

9. The control device according to claim 1, configured to provide driver assist when the front end position of the moving body and the eyellipse reference line become the same position.

10. The control device according to claim 1, configured so as to provide driver assist when the moving body is positioned at the rear from the eyellipse reference line.

11. The control device according to claim 10, configured to judge that the moving body is positioned at the rear from the eyellipse reference line when the front end position of the moving body and the eyellipse reference line become the same position.

12. The control device according to claim 1, configured to, as driver assist, provide alert notification to the driver through a notification device for providing notifications to the driver of the vehicle.

13. A driver assist method by a control device for providing driver assist of a vehicle, wherein
the driver assist method comprising:
detecting a moving body present in the surroundings of a vehicle entering an assist area set in the surroundings of the vehicle; and
providing driver assist when the moving body enters the assist area from a front part of the assist area based on the positional relationship between the front end position of the moving body and the vehicle or based on the positional relationship between the moving body and an eyellipse reference line set for each vehicle.

14. A non-transitory computer storage medium including a computer program for making a computer run processing for:
detecting a moving body present in the surroundings of a vehicle entering an assist area set in the surroundings of the vehicle; and
providing driver assist when the moving body enters the assist area from a front part of the assist area based on the positional relationship between the front end position of the moving body and the vehicle or based on the positional relationship between the moving body and an eyellipse reference line set for each vehicle.
